(19) United States
(12) Patent Application Publication
(10) Pub. No.: US 2014/0208031 A1
(43) Pub. Date: Jul. 24, 2014

(54) APPARATUS AND METHOD FOR MEMORY-HIERARCHY AWARE PRODUCER-CONSUMER INSTRUCTIONS

(71) Applicants: Shlomo Raikin, Ofer (IL); Robert Valentine, Kiryat Tivon (IL); Raanan Sade, Kibutz Sarid (IL); Julius Yuli Mandelbalt, Haifa (IL); Ron Shalev, Ceaseria (IL); Larisa Novakovsky, Haifa (IL)

(72) Inventors: Shlomo Raikin, Ofer (IL); Robert Valentine, Kiryat Tivon (IL); Raanan Sade, Kibutz Sarid (IL); Julius Yuli Mandelbalt, Haifa (IL); Ron Shalev, Ceaseria (IL); Larisa Novakovsky, Haifa (IL)

(21) Appl. No.: 13/994,724

(22) PCT Filed: Dec. 21, 2011
(86) PCT No.: PCT/US11/66630

§ 371 Date: Jun. 15, 2013

(51) Int. Cl. G06F 12/08; G06T 1/60

(52) U.S. Cl. CPC G06F 12/0811; G06F 12/0891; G06T 1/60
USPC 711/122; 711/133; 345/520

(57) ABSTRACT

An apparatus and method are described for efficiently transferring data from a producer core to a consumer core within a central processing unit (CPU). For example, one embodiment of a method comprises: A method for transferring a chunk of data from a producer core of a central processing unit (CPU) to consumer core of the CPU, comprising: writing data to a buffer within the producer core of the CPU until a designated amount of data has been written; upon detecting that the designated amount of data has been written, responsively generating an eviction cycle, the eviction cycle causing the data to be transferred from the fill buffer to a cache accessible by both the producer core and the consumer core; and upon the consumer core detecting that data is available in the cache, providing the data to the consumer core from the cache upon receipt of a read signal from the consumer core.

### BACKGROUND

1. Field of the Invention

This invention relates generally to the field of computer processors. More particularly, the invention relates to an apparatus and method for implementing a memory-hierarchy aware producer-consumer instruction for transferring data between cores in a processor.

2. Description of the Related Art

Referring to FIG. 1, in a model where two cores 101, 102 of a CPU 150 work in a producer-consumer mode with one core 101 as the producer and another core 102 as the consumer, the data transfer between them is performed as illustrated. The producer core 101 (Core 0 in the example) writes using regular store operations which initially arrive at the producer core's Level 1 (L1) cache 110 (i.e., the data is first copied to the L1 cache 110 before ultimately being transferred to the Level 2 (L2) cache 111, the Level 3 (L3) cache 112 and then main memory 100). While the data is still stored within the L1 cache 110 of the producer core 101, the consumer core 102 initially checks for the data in its own L1 cache 113 and misses, then checks for the data in its own L2 cache 115 and misses, and then checks for the data in the shared L3 cache 112 and misses. Finally, the consumer core implements a snoop protocol to snoop the L1 cache 110 of the producer core 101, resulting in a hit. Data is then transferred from the L1 cache 110 of the producer using the snoop protocol.

The foregoing approach suffers from low latency and low bandwidth because the snoop protocol required to perform the data transfer operation is not performance-optimized as are standard read/write processor operations. An additional drawback of existing approaches is the pollution of the cache of the producer core with data it will never consume, thereby evicting data it might need in the future.

As such, a more efficient mechanism is needed for exchanging data between the cores of a CPU.

### BRIEF DESCRIPTION OF THE DRAWINGS

A better understanding of the present invention can be obtained from the following detailed description in conjunction with the following drawings, in which:

FIG. 1 illustrates a prior art processor architecture for exchanging data between two cores of a CPU.

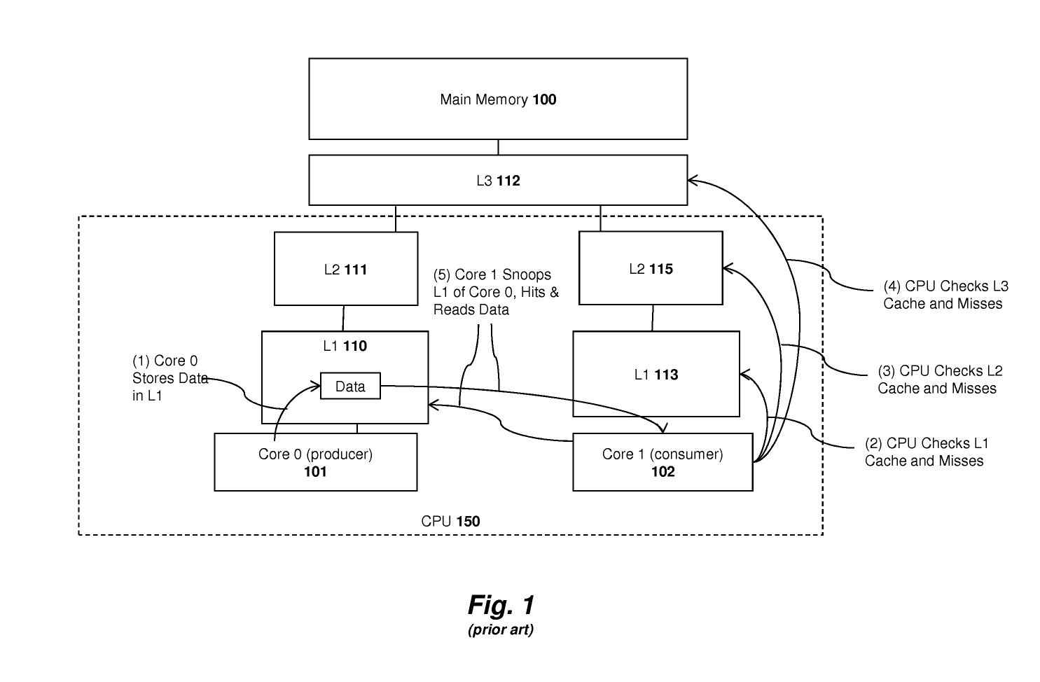

FIG. 2 illustrates a processor architecture in accordance with one embodiment of the invention for exchanging data between a producer core and a consumer core of a CPU.

FIG. 3 illustrates one embodiment of a method for exchanging data between a producer core of a CPU and a consumer core of the CPU.

FIG. 4 illustrates a computer system on which embodiments of the invention may be implemented.

FIG. 5 illustrates another computer system on which embodiments of the invention may be implemented.

FIG. 6 illustrates another computer system on which embodiments of the invention may be implemented.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well- known structures and devices are shown in block diagram form to avoid obscuring the underlying principles of the embodiments of the invention.

In one embodiment, when transferring data from a producer core to a consumer core within a central processing unit (CPU), the producer core will not store the data in its own L1 cache as in prior implementations. Rather, the producer core will execute an instruction to cause the data to be stored in the highest cache level common to both of the CPU cores. For example, if both the producer core and the consumer core have read/write access to the level 3 (L3) cache (also sometimes referred to as the lower level cache) then the L3 cache is used to exchange the data. Note, however, that the underlying principles of the invention are not limited to the use of any particular cache level for exchanging data.

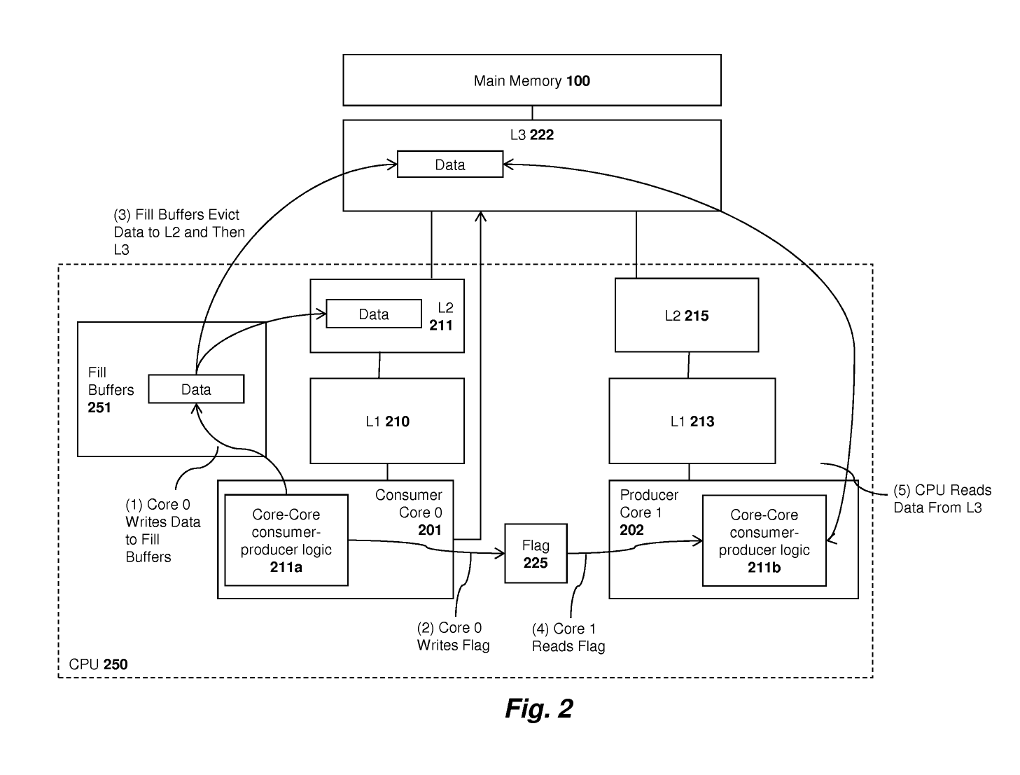

As illustrated in FIG. 2, one embodiment of the invention is implemented within the context of a multi-core central processing unit (CPU) 250. For simplicity, the details of this embodiment of the invention are shown for two cores 201-202, but the underlying principles apply equally to all cores of the CPU 250. The consumer core 201 and the producer core 202 have dedicated L1 caches 201 and 202, respectively, dedicated L2 caches 211 and 215, respectively, and a shared L3 cache 222 and main memory 100.

In operation, core-core producer-consumer logic 211a of the producer core 201 (Core 0 in the example) initially writes the data to be exchanged to fill buffers 251 within the CPU 250. Caches (such as the L1, L2, and L3 caches 212, 213, and 214, respectively) work in cache lines which are a fixed size (64 bytes in one particular embodiment) whereas typical store operations can vary from 1 byte to 64 bytes in size. In one embodiment, the fill buffers 251 are used to combine multiple stores until a complete cache line is filled and then the data is moved between cache levels. Thus, in the example shown in FIG. 2, the data is written to the fill buffers 251 until an amount equal to a complete cache line is stored. An eviction cycle is then generated and the data is moved from the fill buffers 251 to the L2 cache 211 and then from the L2 cache to the L3 cache 222. However, in contrast to prior implementations, an attribute attached to the eviction cycle originating from the fill buffer to the L2 and the L3 caches causes the L3 cache 222 to hold a copy of the data for the data exchange with the consumer core 202.

The core-core producer-consumer logic 211a then writes a flag 225 to indicate that the data is ready for transfer. In one embodiment, the flag 225 is a single bit (e.g., with a ‘1’ indicating that the data is ready in the L3 cache). The core-core consumer-producer logic 211b of the consumer core 202 reads the flag 225 to determine that the data is ready, either through periodic polling by the core-core consumer-producer logic 211b or an interrupt. Once it learns that data is ready in the L3 cache (or other highest common cache level shared with the producer core 201), the consumer core 202 reads the data.

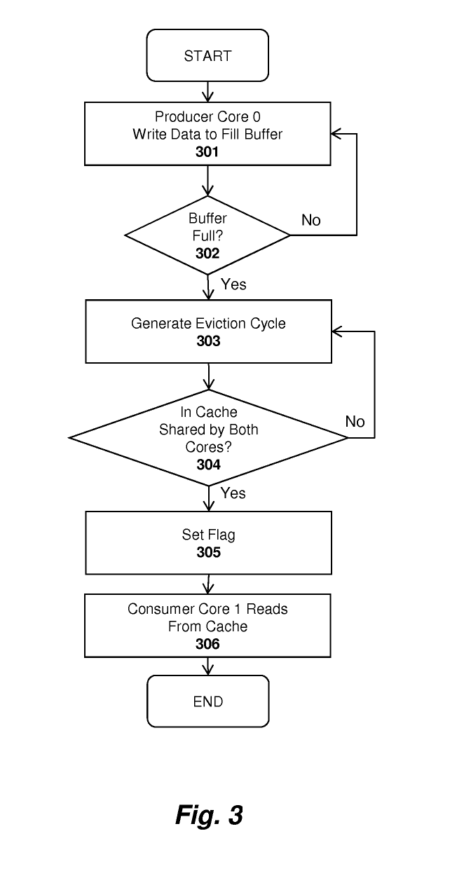

A method in accordance with one embodiment of the invention is illustrated in FIG. 3. The method may be implemented within the context of the architecture shown in FIG. 2, but is not limited to any particular architecture.

At 301, the data to be exchanged is first stored to the fill buffers within the CPU. As mentioned, a chunk of data equal to a complete cache line may be stored within the fill buffers before initiating the data transfer between cache levels. Once the fill buffer is full (e.g., by an amount equal to a cache line) 302, an eviction cycle is generated at 303. The eviction cycle persists until the data is stored within a cache level common to both cores of the CPU, determined at 304. At 305, a flag is set by the producer core to indicate that the data is available for the consumer core and, at 306, the consumer core reads the data from the cache.

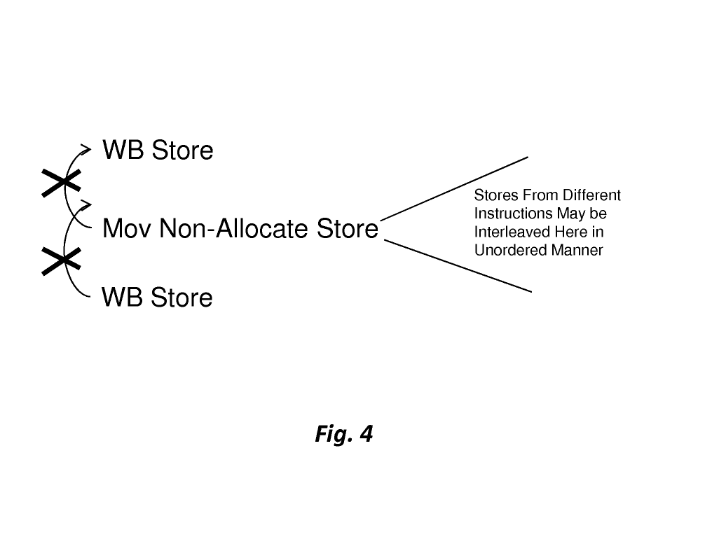

In one embodiment, the data is transferred to the fill buffers and then evicted to the L3 cache using a particular instruction, referred to herein as a MovNonAllocate (MovNA) instruction. As indicated in FIG. 4, in one embodiment, individual MovNA instructions may be interleaved with one another but not with other write-back (WB) store instructions as indicated by the Xs through the arrows (i.e., write bypassing is not permitted), thereby ensuring correct memory ordering semantics in hardware. In this implementation, strong ordering does not need to be enforced by the user with a Fence instruction or similar type of instruction. As is understood by those of skill in the art, a fence instruction is a type of barrier and a class of instruction which causes a central processing unit (CPU) or compiler to enforce an ordering constraint on memory operations issued before and after the fence instruction.

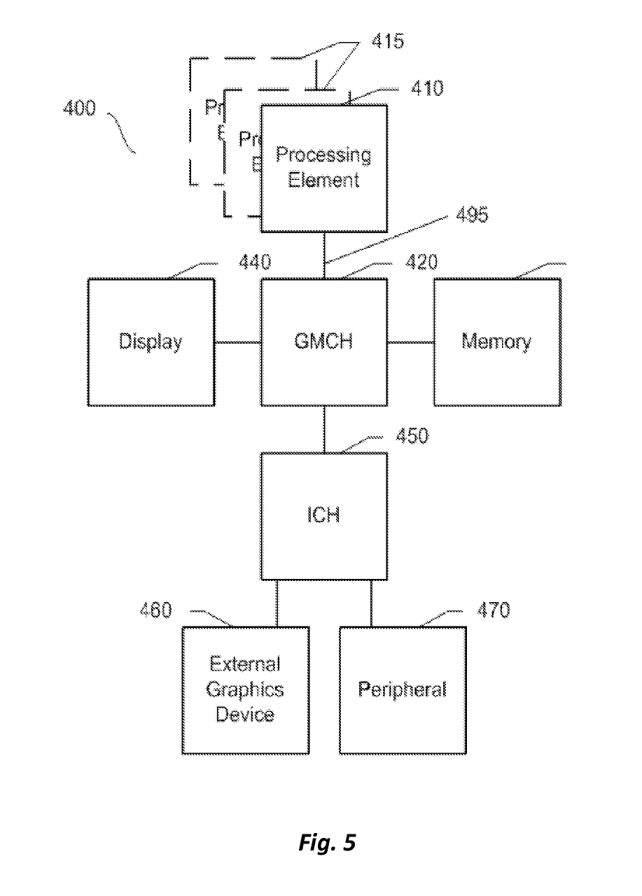

Referring now to FIG. 5, shown is a block diagram of another computer system 400 in accordance with one embodiment of the present invention. The system 400 may include one or more processing elements 410, 415, which are coupled to graphics memory controller hub (GMCH) 420. The optional nature of additional processing elements 415 is denoted in FIG. 5 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 5 illustrates that the GMCH 420 may be coupled to a memory 440 that may be, for example, a dynamic random access memory (DRAM). The DRAM may, for at least one embodiment, be associated with a non-volatile cache.

The GMCH 420 may be a chipset, or a portion of a chipset. The GMCH 420 may communicate with the processor(s) 410, 415 and control interaction between the processor(s) 410, 415 and memory 440. The GMCH 420 may also act as an accelerated bus interface between the processor(s) 410, 415 and other elements of the system 400. For at least one embodiment, the GMCH 420 communicates with the processor(s) 410, 415 via a multi-drop bus, such as a frontside bus (FSB) 495.

Furthermore, GMCH 420 is coupled to a display 440 (such as a flat panel display). GMCH 420 may include an integrated graphics accelerator. GMCH 420 is further coupled to an input/output (I/O) controller hub (ICH) 450, which may be used to couple various peripheral devices to system 400. Shown for example in the embodiment of FIG. 4 is an external graphics device 460, which may be a discrete graphics device coupled to ICH 450, along with another peripheral device 470.

Alternatively, additional or different processing elements may also be present in the system 400. For example, additional processing element(s) 415 may include additional processors(s) that are the same as processor 410, additional processor(s) that are heterogeneous or asymmetric to processor 410, accelerators (such as, e.g., graphics accelerators or digital signal processing (DSP) units), field programmable gate arrays, or any other processing element. There can be a variety of differences between the physical resources 410, 415 in terms of a spectrum of metrics of merit including architectural, microarchitectural, thermal, power consumption characteristics, and the like. These differences may effectively manifest themselves as asymmetry and heterogeneity amongst the processing elements 410, 415. For at least one embodiment, the various processing elements 410, 415 may reside in the same die package.

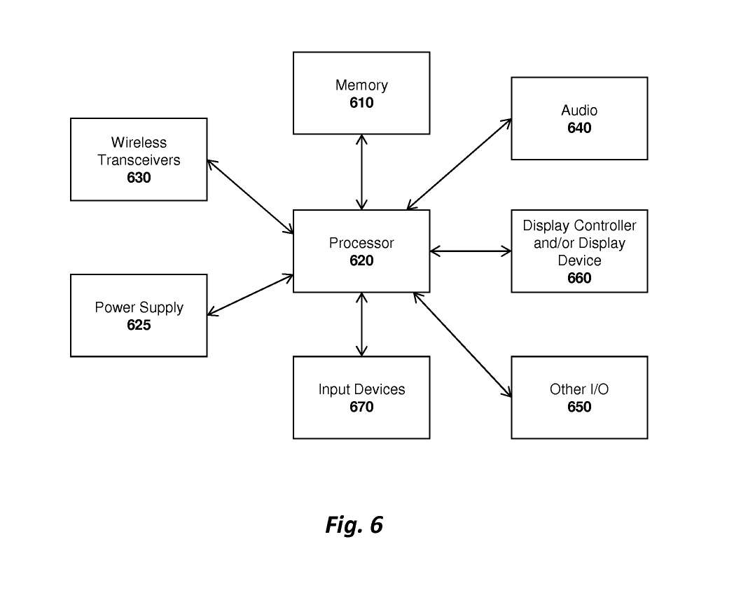

FIG. 6 is a block diagram illustrating another exemplary data processing system which may be used in some embodiments of the invention. For example, the data processing system 500 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 500 may be a network computer or an embedded processing device within another device.

According to one embodiment of the invention, the exemplary architecture of the data processing system 900 may used for the mobile devices described above. The data processing system 900 includes the processing system 520, which may include one or more microprocessors and/or a system on an integrated circuit. The processing system 520 is coupled with a memory 910, a power supply 525 (which includes one or more batteries) an audio input/output 540, a display controller and display device 560, optional input/output 550, input device(s) 570, and wireless transceiver(s) 530. It will be appreciated that additional components, not shown in FIG. 5, may also be a part of the data processing system 500 in certain embodiments of the invention, and in certain embodiments of the invention fewer components than shown in FIG. 55 may be used. In addition, it will be appreciated that one or more buses, not shown in FIG. 5, may be used to interconnect the various components as is well known in the art.

The memory 510 may store data and/or programs for execution by the data processing system 500. The audio input/output 540 may include a microphone and/or a speaker to, for example, play music and/or provide telephony functionality through the speaker and microphone. The display controller and display device 560 may include a graphical user interface (GUI). The wireless (e.g., RF) transceivers 530 (e.g., a WiFi transceiver, an infrared transceiver, a Bluetooth transceiver, a wireless cellular telephony transceiver, etc.) may be used to communicate with other data processing systems. The one or more input devices 570 allow a user to provide input to the system. These input devices may be a keypad, keyboard, touch panel, multi touch panel, etc. The optional other input/output 550 may be a connector for a dock.

Other embodiments of the invention may be implemented on cellular phones and pagers (e.g., in which the software is embedded in a microchip), handheld computing devices (e.g., personal digital assistants, smartphones), and/or touch-tone telephones. It should be noted, however, that the underlying principles of the invention are not limited to any particular type of communication device or communication medium.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

1. A method for transferring a chunk of data from a producer core of a central processing unit (CPU) to consumer core of the CPU, comprising:
writing data to a buffer within the producer core of the CPU until a designated amount of data has been written;
upon detecting that the designated amount of data has been written, responsively generating an eviction cycle, the eviction cycle causing the data to be transferred from the fill buffer to a cache accessible by both the producer core and the consumer core;
setting an indication to indicate to the consumer core that data is available in the cache; and
upon the consumer core detecting the indication, providing the data to the consumer core from the cache upon receipt of a read signal from the consumer core.

2. The method as in claim 1 wherein the indication comprises a flag writable by the core and readable by the consumer core.

3. The method as in claim 2 wherein the flag comprises a binary value indicative having a first value indicating that the data is available in the cache and a second value indicating that data is not available in the cache.

4. The method as in claim 1 wherein the consumer core reads the indication via a polling technique in which the consumer core periodically reads polls for the indication.

5. The method as in claim 1 wherein the consumer core reads the indication in response to an interrupt signal.

6. The method as in claim 1 wherein the operations of the method are executed by the producer core in response to the execution of a first instruction by the producer core.

7. The method as in claim 6 wherein the first instruction comprises a MovNonAllocate store instruction.

8. The method as in claim 6 further comprising:
permitting the first instruction to be interleaved with a plurality of other instructions of the same instruction type.

9. The method as in claim 8 further comprising:
permitting the first instruction to be interleaved with a plurality of other instructions of different instruction types.

10. The method as in claim 9 wherein the other instructions are write-back store instructions and the first instruction is a MovNonAllocate store instruction.

11. The method as in claim 1 wherein the buffer within the producer core is a fill buffer and wherein the cache accessible by both the producer core and the consumer core is a level 3 (L3) cache.

12. An instruction processing apparatus comprising:
a producer core within a central processor unit (CPU) producing data for one or more consumer cores and a cache accessible by the producer core and the one or more consumer cores;
core-core producer-consumer logic configured to perform the operations of:
writing data to a buffer within the producer core of the CPU until a designated amount of data has been written;
upon detecting that the designated amount of data has been written, responsively generating an eviction cycle, the eviction cycle causing the data to be transferred from the fill buffer to a cache accessible by both the producer core and the consumer core;
setting an indication to indicate to the consumer core that data is available in the cache; and
upon the consumer core detecting the indication, providing the data to the consumer core from the cache upon receipt of a read signal from the consumer core.

13. The instruction processing apparatus as in claim 12 wherein the indication comprises a flag writable by the core and readable by the consumer core.

14. The instruction processing apparatus as in claim 13 wherein the flag comprises a binary value indicative having a first value indicating that the data is available in the cache and a second value indicating that data is not available in the cache.

15. The instruction processing apparatus as in claim 12 wherein the consumer core reads the indication via a polling technique in which the consumer core periodically reads polls for the indication.

16. The instruction processing apparatus as in claim 12 wherein the consumer core reads the indication in response to an interrupt signal.

17. The instruction processing apparatus as in claim 12 wherein the operations of the instruction processing apparatus are executed by the producer core in response to the execution of a first instruction by the producer core.

18. The instruction processing apparatus as in claim 17 wherein the first instruction comprises a MovNonAllocate store instruction.

19. The instruction processing apparatus as in claim 17 wherein the core-core producer-consumer logic performs the additional operations of:
permitting the first instruction to be interleaved with a plurality of other instructions of the same instruction type.

20. The instruction processing apparatus as in claim 19 wherein the core-core producer-consumer logic performs the additional operations of:
permitting the first instruction to be interleaved with a plurality of other instructions of different instruction types.

21. The instruction processing apparatus as in claim 20 wherein the other instructions are write-back store instructions and the first instruction is a MovNonAllocate store instruction.

22. The instruction processing apparatus as in claim 12 wherein the buffer within the producer core is a fill buffer and wherein the cache accessible by both the producer core and the consumer core is a level 3 (L3) cache.

23. A computer system comprising:
a graphics processor unit (GPU) for processing a set of graphics instructions to render video; and
a central processing unit comprising:
a producer core within a central processor unit (CPU) producing data for one or more consumer cores and a cache accessible by the producer core and the one or more consumer cores;
core-core producer-consumer logic configured to perform the operations of:
writing data to a buffer within the producer core of the CPU until a designated amount of data has been written;
upon detecting that the designated amount of data has been written, responsively generating an eviction cycle, the eviction cycle causing the data to be transferred from the fill buffer to a cache accessible by both the producer core and the consumer core;
setting an indication to indicate to the consumer core that data is available in the cache; and
upon the consumer core detecting the indication, providing the data to the consumer core from the cache upon receipt of a read signal from the consumer core.

24. An apparatus for transferring a chunk of data from a producer core of a central processing unit (CPU) to consumer core of the CPU, comprising:
means for writing data to a buffer within the producer core of the CPU until a designated amount of data has been written;
means for responsively generating an eviction cycle upon detecting that the designated amount of data has been written, the eviction cycle causing the data to be transferred from the fill buffer to a cache accessible by both the producer core and the consumer core;
means for setting an indication to indicate to the consumer core that data is available in the cache; and
means for providing the data to the consumer core from the cache upon receipt of a read signal from the consumer core.

25. The apparatus as in claim 24 wherein the indication comprises a flag writable by the core and readable by the consumer core.

26. The apparatus as in claim 25 wherein the flag comprises a binary value indicative having a first value indicating that the data is available in the cache and a second value indicating that data is not available in the cache.

27. The apparatus as in claim 24 wherein the consumer core reads the indication via a polling technique in which the consumer core periodically reads polls for the indication.

28. The apparatus as in claim 24 wherein the consumer core reads the indication in response to an interrupt signal.

29. The apparatus as in claim 24 wherein the operations by the producer core are executed in response to the execution of a first instruction by the producer core.

30. The apparatus as in claim 29 wherein the first instruction comprises a MovNonAllocate store instruction.

31. (canceled)

32. (canceled)

33. (canceled)

34. (canceled)
